(19) United States
(12) Patent Application Publication
(10) Pub. No.: US 2018/0350274 A1
(43) Pub. Date: Dec. 6, 2018

(54) MULTI-FUNCTIONAL, INTELLIGENT AND ECO-FRIENDLY TAPE

(71) Applicant: Dongguan Morganprintone SmartTech Co.,Ltd., Guangdong (CN)

(72) Inventor: Haixiong Ruan, Guangdong (CN)

(21) Appl. No.: 15/608,773

(22) Filed: May 30, 2017

(51) Int. Cl. G09F 3/03; G06K 19/07; G06K 19/06; G06K 19/077; C09J 7/02; B33Y 80/00; G09F 3/10

(52) U.S. Cl. CPC G09F 3/0341; G06K 19/0723; G06K 19/06037; G06K 19/025; C09J 7/0235; B33Y 80/00; G09F 3/10; G06K 19/07766

(57) ABSTRACT

A multi-functional, intelligent and eco-friendly tape comprising a base layer, a tag having a RFID function, a two-dimensional code printing layer and a barcode printing layer; the tag having a RFID function is composited with the base layer, and the two-dimensional code printing layer and the barcode printing layer are printed on the front surface of the base layer; through the tag having a RFID function, the two-dimensional code printing layer and the barcode printing layer, the anti-counterfeiting information of the present invention can be read by RFID readers, two-dimensional code readers or barcode readers, resulting in an intelligent anti-counterfeiting function, which is convenient, cost-effective and multi-functional.

### TECHNICAL FIELD OF THE INVENTION

The present invention relates to the technical field of tapes, seals and adhesive stickers, and more particularly, to a multi-functional, intelligent and eco-friendly tape.

### BACKGROUND OF THE INVENTION

Packing tapes commonly used today usually adopt BOPP bi-axially oriented polypropylene film or PET polyester film as a base material. One surface of the base material is uniformly coated with a layer of pressure-sensitive adhesive tape, which can merely be cut open by a scissors and is not bio-degradable, which is obviously harmful to the environment.

The conventional packing tapes sold on the market are single-functional, leading to a high customized cost. Although a part of the anti-counterfeiting tapes can be used to identify a product or connect to an official account through mobile two-dimensional codes, they are difficult to market due to their single function and high manufacturing cost. In the prior art, products in various industries are packed in packing cases and sealed by transparent tapes, making those products vulnerable to counterfeiting. For instance, when the sealing tape is torn off, the packing case shows no sign of having been touched, and when the sealing tape is re-attached on the packing case, it simply looks untouched, providing opportunities to illegal merchants and counterfeiters.

### SUMMARY OF THE INVENTION

The purpose of the present invention is to solve the shortcomings in the prior art and provide a multi-functional, intelligent and eco-friendly tape having an anti-counterfeiting function.

To achieve the above purpose, the present invention adopts the following technical solution:

A multi-functional, intelligent and eco-friendly tape comprising a base layer, a tag having a RFID function, a two-dimensional code printing layer and a barcode printing layer; the tag having a RFID function is composited with the base layer, and the two-dimensional code printing layer and the barcode printing layer are printed on the front surface of the base layer.

In another preferred embodiment, the tag having a RFID function can be a printed tag or an electronic tag, or can be generated through 3D printing.

In another preferred embodiment, the front surface of the base layer is provided with a product information printing layer, a fluorescent layer and a light-reflecting layer.

In another preferred embodiment, the multi-functional, intelligent and eco-friendly tape further comprises a flame-retardant layer, by which the base layer, the two-dimensional code printing layer, the barcode printing layer, the product information printing layer, the fluorescent layer and the light-reflecting layer can be entirely wrapped. The flame-retardant layer is made from a transparent material.

In another preferred embodiment, the multi-functional, intelligent and eco-friendly tape further comprises a penetration-resistant weather-proof layer, and the flame-retardant layer is completely wrapped by the penetration-resistant weather-proof layer. The penetration-resistant weather-proof layer is made from a transparent material.

In another preferred embodiment, the rear surface of the penetration-resistant weather-proof layer is provided with an adhesive layer, and the adhesive layer is covered by a release layer.

Compared with the prior art, the present invention has the following advantages:

Through the tag having a RFID function, the two-dimensional code printing layer and the barcode printing layer, the anti-counterfeiting information of the present invention can be read by RFID readers, two-dimensional code readers or barcode reader. This anti-counterfeiting function is convenient, cost-effective and multi-functional.

Furthermore, the present invention can be customized, which can be made from brown paper, PP or other eco-friendly materials. Meanwhile, the present invention adopts high-quality eco-friendly adhesive having high tensile resistance and viscosity, which is nontoxic and tasteless and can be easily torn off by hand.

### BRIEF DESCRIPTION OF THE DRAWINGS

To clearly expound the present invention or technical solution, the drawings and embodiments are hereinafter combined to illustrate the present invention. Obviously, the drawings are merely some embodiments of the present invention and those skilled in the art can associate themselves with other drawings without paying creative labor.

FIG. 1 is a sectional view of a preferred embodiment of the present invention.

Marking Instructions of the Drawings:

| | |
|---|---|
| 11 [symbol] Base Layer | 12 [symbol] Tag Having a RFID Function |
| 13 [symbol] Two-dimensional Code Printing | 14 [symbol] Barcode Printing Layer |
| Layer | |
| 15 [symbol] Product Information Printing | 16 [symbol] Fluorescent Layer |
| Layer | |
| 17 [symbol] Light-reflecting Layer | 18 [symbol] Flame-retardant Layer |
| 19 [symbol] Penetration-resistant | 20 [symbol] Adhesive Layer |
| Weather-proof layer | |
| 21 [symbol] Release Layer | |

### DETAILED DESCRIPTION OF THE INVENTION

Drawings and detailed embodiments are combined hereinafter to elaborate the technical principles of the present invention.

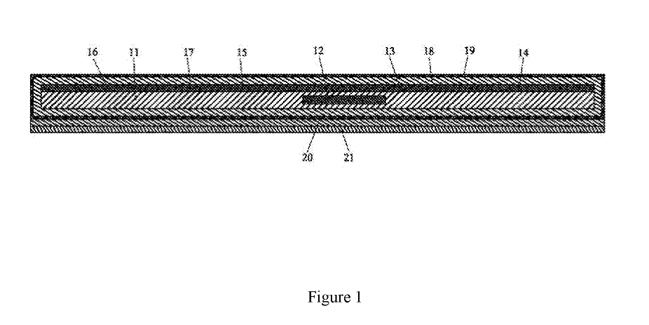

As shown in FIG. 1, the particular structure of a preferred embodiment of the present invention comprises a base layer 11, a tag having a RFID function 12, a two-dimensional code printing layer 13 and a barcode printing layer 14.

The tag having a RFID function 12, which is composited with the base layer, can be a printed tag or an electronic tag, or can be generated through 3D printing. The two-dimensional code printing layer 13 and the barcode printing layer 14 are printed on the front surface of the base layer 11. The tag having a RFID function 12, the two-dimensional code printing layer 13 and the barcode printing layer 14 can store relevant product information.

The front surface of the base layer 11 is provided with a product information printing layer 15, a fluorescent layer 16 and a light-reflecting layer 17. The product information printing layer 15 can display the product information, the fluorescent layer 16 can generate fluorescent light, and the light-reflecting layer 17 can reflect light so that a warning purpose can be achieved.

The present invention further comprises a flame-retardant layer 18, and the base layer 11, the two-dimensional code printing layer 13, the barcode printing layer 14, the product information printing layer 15, the fluorescent layer 16 and the light-reflecting layer 17 can be entirely wrapped by the flame-retardant layer 18. The flame-retardant layer 18, which is made from a transparent material, has a flame-retardant function.

The present invention further comprises a penetration-resistant weather-proof layer 19, and the flame-retardant layer 18 is completely wrapped by the penetration-resistant weather-proof layer 19. The penetration-resistant weather-proof layer 19, which is made from a transparent material, is penetration-resistant and weather-proof.

Furthermore, the rear surface of the penetration-resistant weather-proof layer 19 is provided with an adhesive layer 20, and the adhesive layer 20 is covered by a release layer 21. The adhesive layer is then bonded to the exterior.

During use, the release layer 21 can be easily peeled off, thereby enabling the adhesive layer 20 to be bonded to the exterior. When the anti-counterfeiting information of a product needs to be obtained, the user can place a RFID reader nearby the present invention, and the anti-counterfeiting information can be obtained when the tag having a RFID function 12 is sensed by the RFID reader. Alternatively, a two-dimensional code reader can be used to scan the two-dimensional code printing layer 13, and a barcode reader can be used to scan the barcode printing layer 14, through which the anti-counterfeiting information of the product can also be obtained.

Additionally, through the tag having a RFID function, the two-dimensional code printing layer and the barcode printing layer, the anti-counterfeiting information of the present invention can be read by RFID readers, two-dimensional code readers or barcode readers, and can be further collected and uploaded to the cloud platform system of the Internet of Things (“IOT”). Consequently, the products can be traced, reducing the likelihood of intervening counterfeiting. Furthermore, the present invention has various management applications such as one-code-to-one-commodity, Wechat official account, Wechat shopping mall, marketing application, client CRM system, channel distribution and data marketing, which can bring great convenience to users.

Moreover, the present invention can be applied in seals and anti-counterfeiting packages of various industries, including packing seals, assets management seals, safety-warning seals, fire-fighting equipment warranty seals, and anti-counterfeiting packages of luxury cigarettes and wines, agricultural products, foods, fast-moving consumer goods, electronic products, medicines, clothes, shoes, daily chemicals and mother and baby products. Through the multi-functional tape printed with a barcode, two-dimensional code, and RFID signal, goods in various industries can be interconnected, and the management applications of the Internet of Things can be achieved.

The previous descriptions are of preferred examples for implementing the invention, and the scope of the invention should not necessarily be limited by this description. The scope of the present invention is defined by the claims.

1. A multi-functional, intelligent and eco-friendly tape, comprising:
a base layer,
an electronic tag having an RFID function,
a two-dimensional code printing layer, and
a barcode printing layer, wherein the tag having a RFID function is composited with the base layer, wherein the two-dimensional code printing layer and the barcode printing layer are printed on the front surface of the base layer,
wherein at least one layer is made from eco-friendly material.

2. The multi-functional, intelligent and eco-friendly tape of claim 1,
wherein the electronic tag having an RFID function can be can be generated through 3D printing.

3. The multi-functional, intelligent and eco-friendly tape of claim 1, wherein the front surface of the base layer is provided with a product information printing layer, a fluorescent layer and a light-reflecting layer.

4. The multi-functional, intelligent and eco-friendly tape of claim 3, wherein the multi-functional, intelligent and eco-friendly tape further comprises a flame-retardant layer, in which the base layer, the two-dimensional code printing layer, the barcode printing layer, the product information printing layer, the fluorescent layer and the light-reflecting layer can be entirely wrapped, and wherein the flame-retardant layer is made from a transparent material.

5. The multi-functional, intelligent and eco-friendly tape of claim 4, wherein the multi-functional, intelligent and eco-friendly tape further comprises a penetration-resistant weather-proof layer, wherein the flame-retardant layer is completely wrapped by the penetration-resistant weather-proof layer, and wherein the penetration-resistant weather-proof layer is made from a transparent material.

6. The multi-functional, intelligent and eco-friendly tape of claim 5, wherein the rear surface of the penetration-resistant weather-proof layer is provided with an adhesive layer, wherein the adhesive layer is covered by a release layer.

7. The multi-functional, intelligent and eco-friendly tape of claim 1, wherein at least two layers are made from eco-friendly materials.

8. The multi-functional, intelligent and eco-friendly tape of claim 1, wherein the eco-friendly material is polypropylene.

9. The multi-functional, intelligent and eco-friendly tape of claim 1, wherein the eco-friendly material is paper.

10. The multi-functional, intelligent and eco-friendly tape of claim 9, wherein the paper is brown paper.

11. The multi-functional, intelligent and eco-friendly tape of claim 1, wherein the electronic tag having an RFID function, the two-dimensional code printing layer, and the barcode printing layer, contain anti-counterfeiting information.

12. The multi-functional, intelligent and eco-friendly tape of claim 11, wherein the anti-counterfeiting information is automatically uploaded to the cloud platform system of IOT upon scanning.
